(19) United States
(12) Patent Application Publication
(10) Pub. No.: US 2024/0256866 A1
(43) Pub. Date: Aug. 1, 2024

(54) GENERATING AI DATASET USING 3D ENGINE

(71) Applicant: Raytheon Company, Waltham, MA (US)

(72) Inventors: James Ryland, Dallas, TX (US); Philip A. Sallee, South Riding, VA (US); Steven D. Werner, Garand, TX (US)

(21) Appl. No.: 18/446,964

(22) Filed: Aug. 9, 2023

Related U.S. Application Data
(60) Provisional application No. 63/482,243, filed on Jan. 30, 2023.

(51) Int. Cl. G06N 3/08; G06N 3/0475; G06T 15/50; G06T 19/00

(52) U.S. Cl. CPC G06N 3/08; G06N 3/0475; G06T 15/50; G06T 19/00

(57) ABSTRACT

Embodiments regard improving machine learning (ML) training dataset generation. A method includes receiving or generating, by a scene editor, an image, augmenting, using procedural generation, the image to include a three-dimensional (3D) model of an object resulting in a synthetic image, and generating, by a generative model and based on the synthetic image, a realistic image.

### RELATED APPLICATION

This application claims the benefit of priority to U.S. Provisional Patent Application No. 63/482,243, titled “Generating AI Dataset Using 3D Engine” and filed on Jan. 30, 2023, which is incorporated herein by reference in its entirety.

### TECHNICAL FIELD

Embodiments provide improved diversity in an at least partially synthetic dataset.

### BACKGROUND

Current synthetic imagery and corresponding synthetic imagery datasets suffer from, among other issues, lack of background diversity. Massive amounts of labeled examples are required to train deep learning (DL) models, such as automatic target recognition (ATR) models. There is often a lack of diversity in backgrounds and object pose and lighting conditions. This is especially true for rare targets or targets that are hard to find “in the wild”. Use of synthetic and augmented data is common practice but has serious limitations. Existing approaches to augment data either 1) fail to increase background diversity, 2) result in unrealistic imagery, or 3) are labor and/or time intensive. Examples of labor and/or time intensive image generation includes performing geometric and photometric transforms, computer generated image (CGI)/three-dimensional (3D) renderings, physics-based synthesis (e.g., digital imaging and remote sensing image generation (DIRSIG®)), or traditional generative adversarial network (GAN) generation.

### BRIEF DESCRIPTION OF THE DRAWINGS

FIG. 1 illustrates, by way of example, a diagram of an embodiment of a system for generating a training dataset of images.

FIGS. 2 and 3 illustrate, by way of example, respective diagrams of embodiments of part of the input and a corresponding output of the system of FIG. 1.

FIG. 4 illustrates, by way of example, a flow diagram of an embodiment of a method for generating a training dataset.

FIG. 5 illustrates, by way of example, a diagram of an embodiment of a method for improved training dataset generation.

FIG. 6 is a block diagram of an example of an environment including a system for neural network (NN) training.

FIG. 7 illustrates, by way of example, a block diagram of an embodiment of a machine in the example form of a computer system within which instructions, for causing the machine to perform any one or more of the methods discussed herein, may be executed.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Embodiments can solve at least two problems. Generative models, such as generative adversarial networks (GANs) often fail to keep global aspects of large images consistent (e.g., shading, lighting, shadows, object geometry, or the like). However, the generative models excel at generating locally convincing parts of images. This makes generative models less suitable for generating convincing forgeries of image content like aerial imagery. This is at least in part because many global scene characteristics will likely be obviously wrong or distorted in the generated imagery. For example one building may have its shadow pointed to the west, and another building might have its shadows pointed to the east, suggesting an impossible lighting angle. The problems solved by embodiments can include solving (1) the failure of generative models to keep aspects of images consistent and generate competent forged aerial imagery, such as for counter intelligence and misinformation generation; and (2) the failure of generative models to keep aspects of large images consistent, such as to generate large convincingly realistic but procedural imagery (e.g., aerial imagery) datasets used to train or augment the training of neural network (NN) models such as classifiers or object detectors.

Embodiments provide an end-to-end pipeline for generating a synthetic image or an at least partially synthetic dataset. Real satellite imagery can be sourced, such as from Cesium for Unreal from Cesium of Philadelphia, Pennsylvania, United States of America (USA). Cesium for Unreal brings a 3D geospatial ecosystem to Unreal Engine from Epic Games, Inc. of Cary, North Carolina USA. Cesium combines a high-accuracy full-scale World Geodetic System (WGS) 84 globe, open application programming interfaces (APIs) and open standards for spatial indexing such as 3D tiles, and cloud-based real-world content from Cesium ion with Unreal Engine. WGS 84, defines an Earth-centered, Earth-fixed coordinate system and a geodetic datum standard, and also describes the associated Earth Gravitational Model (EGM) and World Magnetic Model (WMM). The standard is published and maintained by the United States National Geospatial-Intelligence Agency and enables 3D geospatial software.

Fake planes, buildings, and other objects can be combined in a 3D editor (e.g., implemented with a game engine like Unreal Engine), which gives the fake objects consistent geometry, global illumination, and shadow geometry. These raw synthetic images can be processed by a generative NN, such as a cycle generative adversarial network (CycleGAN). The generative NN can remove typical image artifacts associated with the fake objects and the real objects over real backgrounds. For example, the generative network adds and adjusts complex interactions with lighting, color matching with similar objects, decals and weathering, and edge clarity for the fake objects, among other more subtle tells of fakery. The generative network also adds details associated with sensor characteristics like dynamic range, signal-to-noise ratio (SNR), and blur. These sensor characteristics are effects that can be compensated by the generative model. This processing by the generative model (sometimes called a “generative model”) provides tailored forgeries based on real-world sensing data that is more convincing to a human and machine analyst than an image generated by a 3D editor.

Using procedural generation, fake 3D objects can be added, removed, swapped, or a combination thereof, with different models in a procedural manner. Using procedural generation, a position of a camera can be adjusted (zoom, height, angle), with each new object. The 3D engine can automatically adjust many aspects of scene configuration keeping image aspects, like global illumination and shadow consistent. This allows the pipeline to generate data internally. The internally generated data can be used to train the generative model. The training generates a generative model that works with specific environments and objects, such as to give more realistic results. Further, once trained, the generative model can process these procedurally generated images to generate arbitrarily large, diverse, and realistic image datasets for training other models.

The pipeline bootstraps the training of the generative model, which makes images more realistic, using images that the pipeline itself generated. Embodiments combine a 3D scene editor (e.g., written in a real-time 3D game engine), that calculates realistic global image qualities, but fails to wholly account for a myriad of local real world scene complexity, with a generative model which can convincingly fake the results of that local real world scene complexity, while itself being insufficient to capture global scene characteristics. The editor allows for moving, relocating, re-scaling, rotating, and replacing forged objects in the scene since they are all represented as actual 3D models within the editor prior to generative cleanup.

Embodiments are unique for several reasons: 1. Generative models are typically not applied to naturalize 3D rendered objects over real-world images. Embodiments include a subtle use of generative models which are typically used for more pronounced image generation or changes. 2. Real-Time 3D editors are not typically paired with generative models at all. 3. The pipeline can procedurally generate its own training data for training the generative model, and no specialized training set is needed.

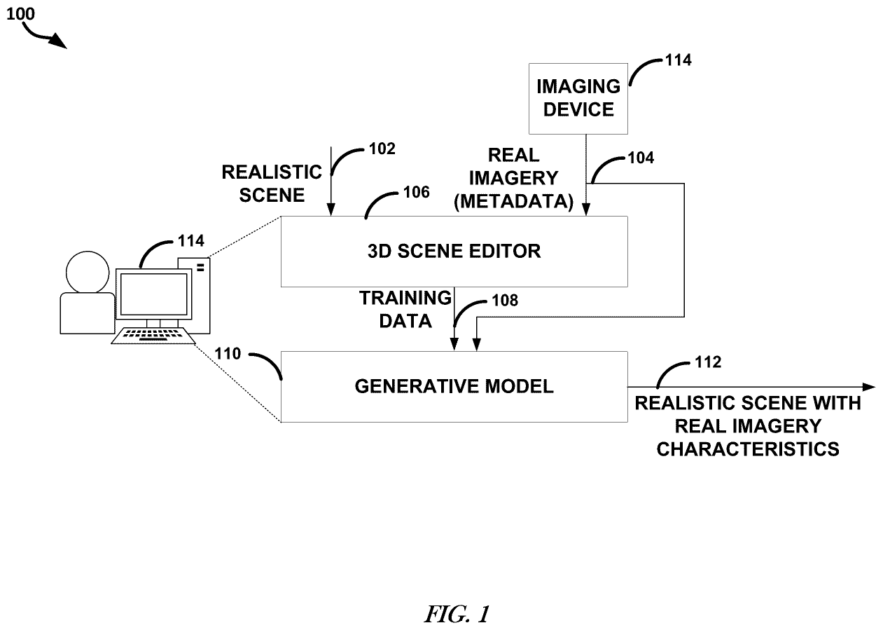

FIG. 1 illustrates, by way of example, a diagram of an embodiment of a system 100 for generating a training dataset of images. Using the system 100, a user can situate one or more digitally rendered objects in a scene. The system 100 can be used to generate a realistic looking image that includes the digitally rendered object. Note that a rendered object is distinguished from a real object. A rendered object is one that is fake, virtual, or the like. A real object is one that was actually present at a geographical location at a time an image was captured.

The system 100 as illustrated includes a 3D scene editor 106 and a generative model 110. The 3D scene editor 106 can be accessible through a user interface (UI) of a compute device 114. The 3D scene editor 106 can be hosted remote from or local on the compute device 114. The 3D scene editor 106 allows a user to augment an image, such as a realistic scene 102 or real imagery 104. The realistic scene 102 is at least partially digitally altered or generated. The real imagery 104 is an unaltered image from an imaging device 114, such as a radar, sonar, electro-optical, color, grayscale, infrared, superspectral, or other imaging device. The real imagery 104 can include metadata that indicates a time of day, view angle, geolocation, or the like that can be used to derive a sun location that indicates a lighting angle. The lighting angle can be used to set a light source location or lighting angle in the 3D scene editor, such as to keep shadows, specular, reflection, or the like, consistent.

The 3D scene editor 106 allows the user to place a 3D model into a 3D scene. The 3D model is of an object. The object can be a real object or a virtual object. Real objects include a vehicle (e.g., an airborne, land, watercraft, or the like), a person, an animal, a plant, a building, a road, a geographic object (e.g., a mountain, rock, desert, land, body of water, or the like), an appliance, a tool, or the like. Virtual objects are any objects that are based on real objects, but are altered so as to be intentionally different from a real object or are just non-existent.

The 3D scene editor 106 allows the user to move, relocate, re-scale, rotate, and replace objects in the realistic scene 102 or the real imagery 104. The objects added by the user to a given scene in the scene editor 106 is represented as a 3D model within the editor 106 prior to generative cleanup. The 3D scene editor 106 allows the user to add fake objects to the scene. Then, the 3D scene editor 106 keeps consistent geometry, global illumination, and shadow geometry for the objects added to the 3D scene and for objects within the scene for which there is a 3D model. The 3D scene editor 106 natively renders realistic scenes. The 3D scene editor 106 exposes a complex user interface (UI) for complex object interaction. A complex UI is distinguished from a simple UI. A UI is complex if it includes maintenance of an application state. A UI is simple is it does not maintain application state.

The 3D scene editor 106 allows the user to choose scene composition, place the objects, and indicate plausible locations for the objects. Indicating plausible locations for the objects can include labeling the scene. The user can label a location in the scene and link the label to a 3D model of an object to indicate which object is plausible at the given location. The user can indicate ranges of values for viewpoint, orientation of the object, lighting direction, or the like. The 3D scene editor 106 can generate distinct images with different combinations of the object at labeled locations, different viewpoints, different lighting directions, orientation of the object, or the like. The labeling and generation of the distinct images is sometimes called procedural generation.

Procedural generation is typically used to create content for video games or animated movies. In embodiments, procedural generation is used to generate a training dataset for an ML model.

As previously discussed, the 3D scene editor 106 can keep global characteristics of an image consistent. The global characteristics can include shadow, illumination angle, or other characteristics that are consistent across the scene. A generative model 110, in contrast to the 3D scene editor 106, keeps local characteristics of individual objects consistent. The generative model 110 can remove typical image artifacts associated with the fake objects and the real objects over real backgrounds. For example, the generative network 110 can add and adjust complex interactions with lighting, color matching with similar objects, decals and weathering, and edge clarity for the fake objects, among other more subtle details or local characteristics of training data 108. The output of the generative model 110 is an image 112 of a realistic scene with real imagery characteristics. The image 112 can be used as further training data for the generative model 110. The image 112 can be used as the realistic scene 102 in a later iteration of procedural generation to generate the training data 108.

Cycle GAN is an example of the generative model 110. Cycle GAN performs an image-to-image translation that includes generating a new synthetic version of a given image with a specific modification. Training a generative model typically includes a large dataset of paired examples. Cycle GAN, however, does not require such paired examples. Cycle GANs are trained in an unsupervised manner using two collections of images, one in a source domain (the training data 108 in the example of the system 100) and one in a target domain (the real imagery 104). The Cycle GAN learns to convert the training data 108 to look more like the real imagery 104. In the example in which the real imagery is from Cesium, the Cycle GAN learns to convert the training data 108 to overhead imagery such as satellite or drone imagery. Other applications include converting to or from multi-spectral data, converting between high and low resolution imagery, converting from blurry imagery to sharp imagery, converting between image types, such as grayscale to color, thermal to color, vice versa, or the like, or cross-domain image search and retrieval, among others.

Example 3D game engines that have 3D scene editors 106 or can include 3D scene editors include Godot, an open source game engine, and Unity from Unity Software Inc. of San Francisco, California, USA, or Unreal Engine (discussed previously), Open 3D, an open source game engine, Panda3D, an open source scene editor and game engine, or the like. Example 3D scene editors, outside of game engines, include Blender, computer aided design and drafting (CAD), DAZ 3D from Daz Productions Inc of Salt Lake City, Utah, USA, SketchUp from Trimble of Westminster, Colorado, USA, and Maya from Autodesk Inc of San Francisco, California, USA, among others. The real imagery 104 can be from DigitalGlobe, Google Earth®, the United States Geological Survey (USGS), National Oceanic and Atmospheric Administration (NOAA), Cesium, Earth Observing Systems Data Analaytics (EOSDA) LandViewer, NASA Earthdata Search, or other imaging provider or service. The realistic scene 102 is any altered image that can be rendered and interacted with using the 3D scene editor 106.

Note CycleGAN is just an example of a generative network, Unreal Engine is just an example of a scene rendering tool, and Cesium is just an example of an image streaming tool and other generative networks, scene rendering tools, and image streaming tools can be used in place of those tools.

In embodiments, a system 100 that includes a 3D engine (the 3D scene editor 106) and the generative model 110 architecture provide highly realistic but fake images. The 3D engine provides scene consistency including shading and lighting consistency while allowing a user to add or remove objects from a scene. Embodiments use a combination of sensed data (the real imagery 104) and physical models (the 3D models that are placed using the 3D scene editor 106). The generative model 110 adjusts the output of the 3D scene editor 106, the training data 108 (an altered version of the real imagery 104 or the realistic scene 102) to appear more realistic by matching image characteristics of an image generated by the imaging device 114.

Using embodiments applied to overhead imagery, the process of generating the realistic scene 112 can be scripted to enable an efficient synthetic data generation pipeline suitable for training machine learning (ML) models. Example ML models include automatic target recognition (ATR) models. The synthetically added objects can be intrinsically labeled through the generation process. Scene attributes can be scripted to be read, by the scene editor 106, from metadata (e.g., light source, direction, etc.) and can be leveraged to increase photogrammetric accuracy. Rare targets can be pictured in arbitrary environments in which they have never been sensed. Using embodiments, synthetic datasets, even a dataset that includes a rare target, can be crafted for specific mission needs, such as to match expected operational parameters.

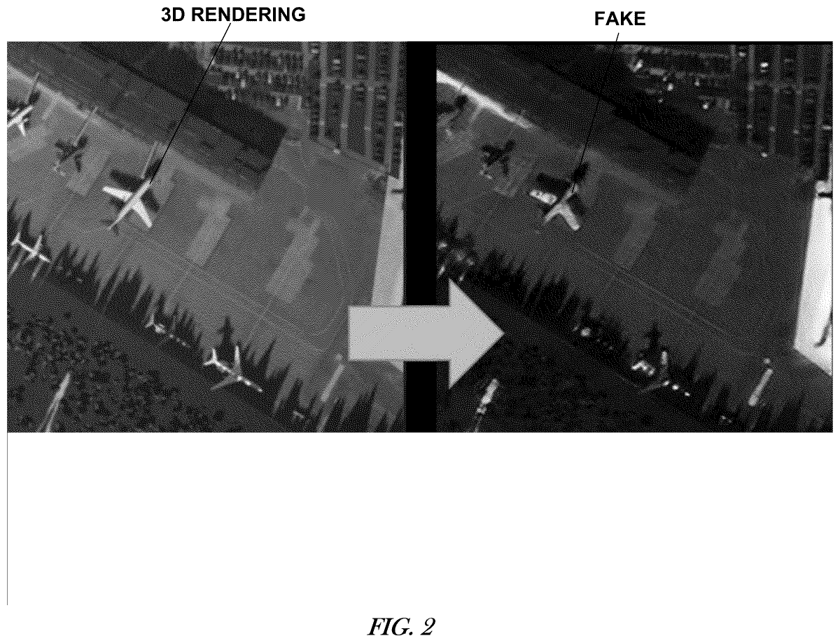

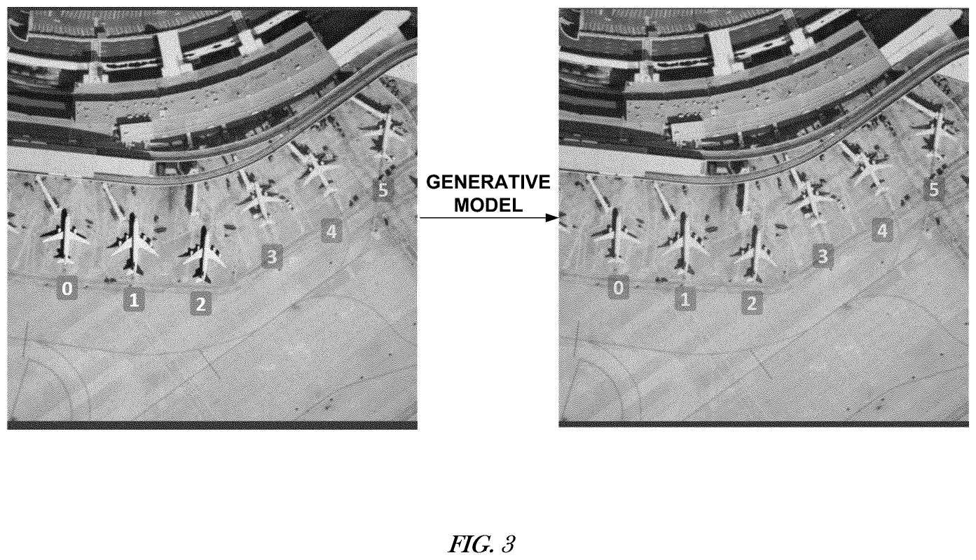

FIGS. 2 and 3 illustrate, by way of example, respective diagrams of embodiments of part of the input and a corresponding output of the system 100 of FIG. 1. In FIGS. 2 and 3, the respective images on the left are output from procedural generation. The respective images on the left were augmented using the scene editor 106. The edited scene (part of training data 108) was then input to the generative model 110 to produce the image on the right. The respective images on the right are examples of the realistic scene 112. It is evident that the planes and shadows are more uniform in the respective images on the right than they are in the respective images on the left.

The input into the 3D scene editor 106 that was used to generate the respective images on the left includes shape, color, shadow, and orientation. The input to generate the respective images on the left is lacking contrast, decals, erosion, shading detail, atmospheric effects, sensor grain, natural image defects, and optic blur, among others. The respective images on the right includes, from the generative model 110, sensor grain, blurring, contextually adjusted shadows, proper albedo, and some plane details that are all consistent with the real imagery 104.

In FIG. 3, the airplanes labeled “0”, “1”, “2” in the image on the right were added to real imagery using the scene editor 106. Then, the image with the added airplanes was input into the generative model 110 to generate the image on the right. The image on the right includes, from the generative model 110, sensor grain, blurring, contextually adjusted shadows, proper albedo, and some plane details.

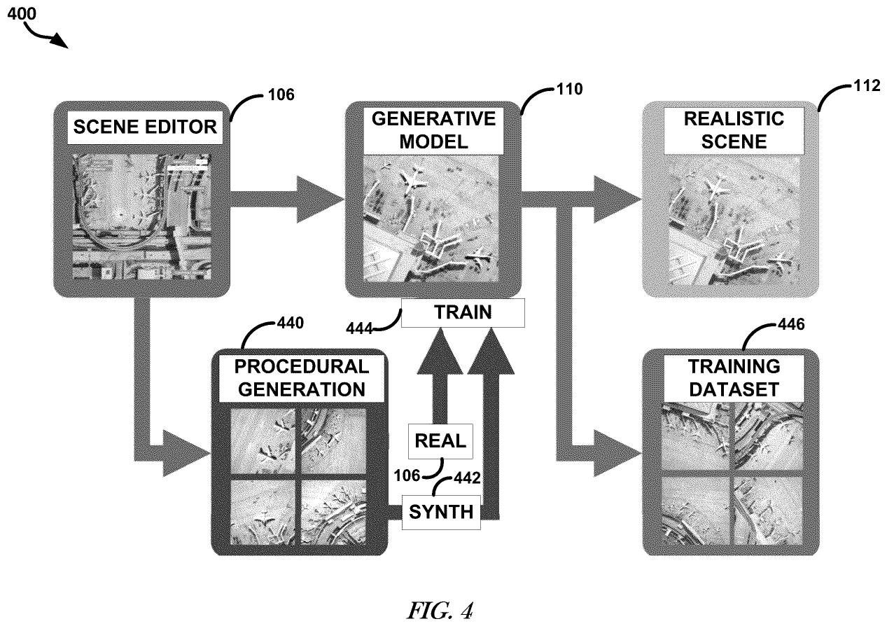

FIG. 4 illustrates, by way of example, a flow diagram of an embodiment of a method 400 for generating a training dataset 446. The training dataset 446 can be used to train an ML model, such as for object recognition or another application. The method 400 as illustrated includes procedural generation 440 of synthetic images 442. The procedural generation 440 includes using the scene editor 106. Using the scene editor 106 for procedural generation 440 can include the user labeling locations of a scene at which it is realistic to locate an object. Using the scene editor 106 for procedural generation 440 can include the user labeling locations with an indication of the object that is realistic to situate in that location. Using the scene editor 106 for procedural generation 440 can include the user indicating an orientation of the object, such as an angle between 0 and 360 degrees relative a baseline orientation of the object.

The procedural generation 440 can include iterating through the labels generated by the user. For each label or a combination of labels, the procedural generation 440 can generate an image. In this manner, the user of the scene editor 106 can quickly generate more synthetic images 442 than is typical. To generate a given image, the user only needs to add a label or multiple labels. This is compared to instances in which the user generates a single image by importing a 3D model, orienting the 3D model, altering characteristics of the scene to make the scene more realistic with the 3D model, and so on. The training data 108 is an instance of the synthetic images 442.

The synthetic images 442 from procedural generation 440 can be used along with the real images 104 to train 444 the generative model 110. Training the generative model 110 includes altering parameters of a generator network so that it generates images that pass scrutiny by a discriminator network. The generator network receives the synthetic image 442 and produces an output image. The discriminator network receives the output image and the real image 104. The discriminator network produces an output that indicates which image, of the output image and the real image, is real. The parameters of the generator network are altered to cause the discriminator network to select the output image. In this way, the generator network learns how to alter the synthetic image 442 to make it more like the real image 104.

After training 444, the generator network of the generative model 110 generates the realistic scene 112. The realistic scene 112 can be used as an image of a training dataset 446 of images. After training 444, procedural generation 440 can continue to be used to generate synthetic images 442 that are input into the generative model 110. The procedural generation 440, along with the generative model 110 can be used to efficiently generate the training dataset 446. The training dataset 446 can be generated in days, months, or longer if done with just a 3D editor but can be generated much more efficiently, such as within minutes to hours, using the systems discussed herein.

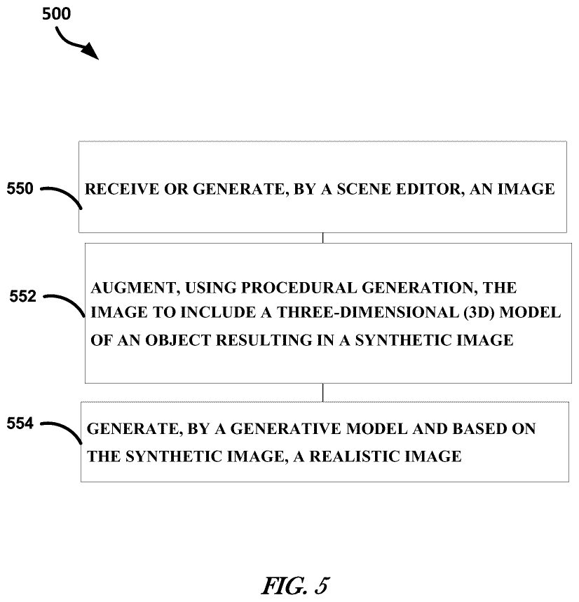

FIG. 5 illustrates, by way of example, a diagram of an embodiment of a method 500 for improved training dataset generation. The method 500 as illustrated includes receiving or generating, by a scene editor, an image, at operation 550; augmenting, using procedural generation, the image to include a three-dimensional (3D) model of an object resulting in a synthetic image, at operation 552; and generating, by a generative model and based on the synthetic image, a realistic image, at operation 554.

The method 500 can further include training, based on real imagery from an imaging sensor and synthetic images from the scene editor, the generative model. The imaging sensor can generate overhead imagery. The synthetic image can include an object placed at a geographical location, in an orientation, or for which real imagery is otherwise not available.

Procedural generation can include labelling locations in the synthetic image at which to locate the 3D model. Procedural generation can further include generating, for each label or combination of labels, a synthetic image of the synthetic images consistent with the label or combination of labels. The method 500 can further include receiving, by the scene editor, metadata of the image. The method 500 can further include automatically adjusting, by the scene editor, a lighting angle, shadow, or combination thereof, of the 3D model based on the metadata.

Artificial Intelligence (AI) is a field concerned with developing decision-making systems to perform cognitive tasks that have traditionally required a living actor, such as a person. Neural networks (NNs) are computational structures that are loosely modeled on biological neurons. Generally, NNs encode information (e.g., data or decision making) via weighted connections (e.g., synapses) between nodes (e.g., neurons). Modern NNs are foundational to many AI applications, such as object recognition, device behavior modeling (as in the present application) or the like. The generative model, or other component or operation can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph-if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

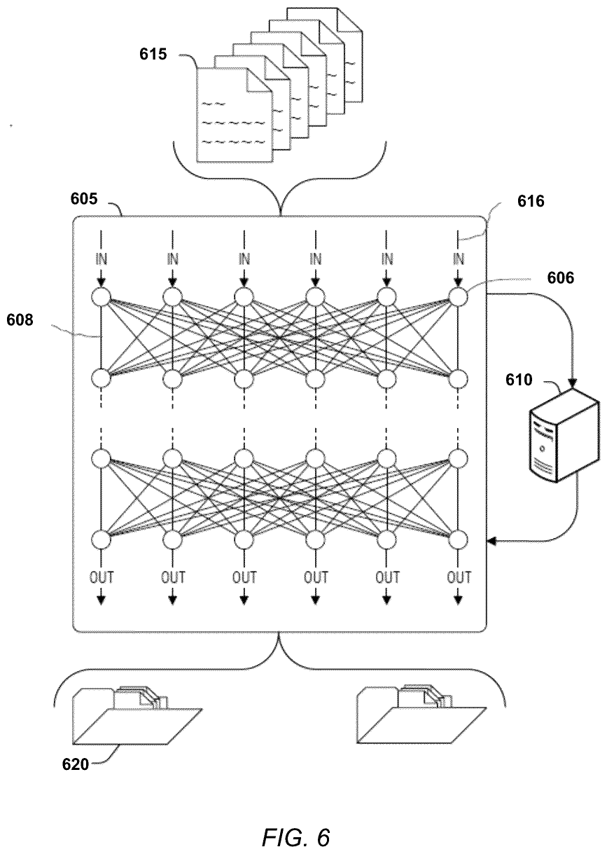

FIG. 6 is a block diagram of an example of an environment including a system for neural network (NN) training. The system includes an artificial NN (ANN) 605 that is trained using a processing node 610. The processing node 610 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 605, or even different nodes 607 within layers. Thus, a set of processing nodes 610 is arranged to perform the training of the ANN 605. The generative model 110 can be trained using the system.

The set of processing nodes 610 is arranged to receive a training set 615 for the ANN 605. The ANN 605 comprises a set of nodes 607 arranged in layers (illustrated as rows of nodes 607) and a set of inter-node weights 608 (e.g., parameters) between nodes in the set of nodes. In an example, the training set 615 is a subset of a complete training set. Here, the subset may enable processing nodes with limited storage resources to participate in training the ANN 605.

The training data may include multiple numerical values representative of a domain, such as an image feature, or the like. Each value of the training or input 617 to be classified after ANN 605 is trained, is provided to a corresponding node 607 in the first layer or input layer of ANN 605. The values propagate through the layers and are changed by the objective function.

As noted, the set of processing nodes is arranged to train the neural network to create a trained neural network. After the ANN is trained, data input into the ANN will produce valid classifications 620 (e.g., the input data 617 will be assigned into categories), for example. The training performed by the set of processing nodes 607 is iterative. In an example, each iteration of the training the ANN 605 is performed independently between layers of the ANN 605. Thus, two distinct layers may be processed in parallel by different members of the set of processing nodes. In an example, different layers of the ANN 605 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 607 (e.g., neurons) are trained independently. In an example, the nodes are trained on different hardware.

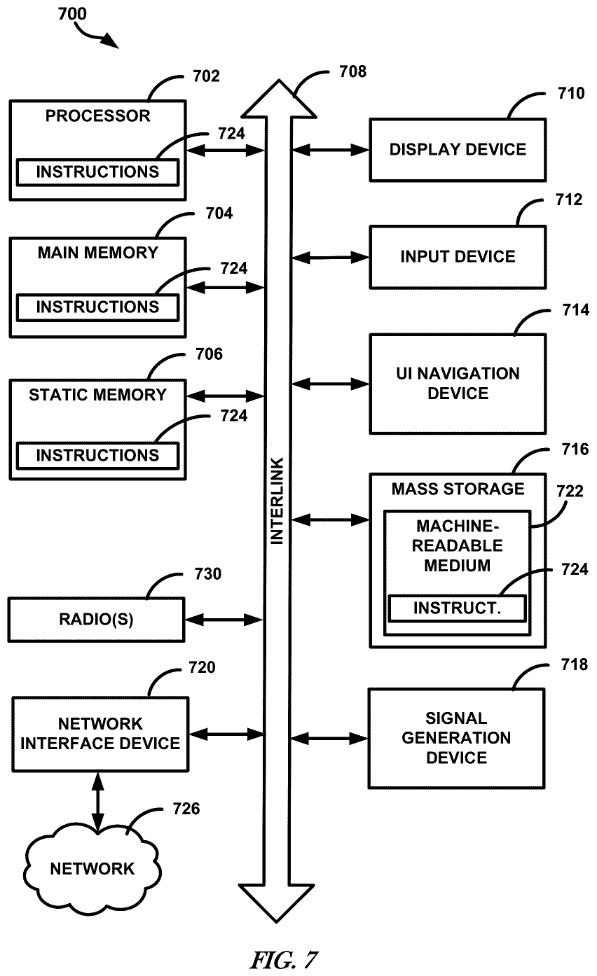

FIG. 7 illustrates, by way of example, a block diagram of an embodiment of a machine in the example form of a computer system 700 within which instructions, for causing the machine to perform any one or more of the methods discussed herein, may be executed. One or more of the generative model 110, 3D scene editor 106, imaging device 114, method 400, 600, training system of FIG. 6, or other device, component, operation, or method discussed can include, or be implemented or performed by one or more of the components of the computer system 700. In a networked deployment, the machine may operate in the capacity of a server or a client machine in server-client network environment, or as a peer machine in a peer-to-peer (or distributed) network environment. The machine may be a personal computer (PC), server, a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a mass storage unit 716, a signal generation device 718 (e.g., a speaker), a network interface device 720, and a radio 730 such as Bluetooth, WWAN, WLAN, and NFC, permitting the application of security controls on such protocols.

The mass storage unit 716 includes a machine-readable medium 722 on which is stored one or more sets of instructions and data structures (e.g., software) 724 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present invention, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 724 may further be transmitted or received over a communications network 726 using a transmission medium. The instructions 724 may be transmitted using the network interface device 720 and any one of a number of well-known transfer protocols (e.g., HTTPS). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### Additional Notes and Examples

Example 1 includes a method for machine learning (ML) training dataset generation, the method comprising receiving or generating, by a scene editor, an image, augmenting, using procedural generation, the image to include a three-dimensional (3D) model of an object resulting in a synthetic image, and generating, by a generative model and based on the synthetic image, a realistic image.

In Example 2, Example 1 further includes training, based on real imagery from an imaging sensor and synthetic images from the scene editor, the generative model.

In Example 3, Example 2 further includes, wherein the imaging sensor generates overhead imagery.

In Example 4, Example 3 further includes, wherein the synthetic image includes an object placed at a geographical location, in an orientation, or for which real imagery is otherwise not available.

In Example 5, at least one of Examples 1-4 further includes, wherein procedural generation includes labelling locations in the synthetic image at which to locate the 3D model.

In Example 6, Example 5 further includes 6, wherein procedural generation further includes generating, for each label or combination of labels, a synthetic image of the synthetic images consistent with the label or combination of labels.

In Example 7, at least one of Examples 1-6 further includes receiving, by the scene editor, metadata of the image, and automatically adjusting, by the scene editor, a lighting angle, shadow, or combination thereof, of the 3D model based on the metadata.

Example 8 includes a non-transitory machine-readable medium including instructions that, when executed by a machine, cause the machine to perform operations for machine learning (ML) training dataset generation, the operations comprising the method of at least one of Examples 1-7.

Example 9 includes a system for machine learning (ML) training dataset generation, the system comprising processing circuitry and a memory including instructions that, when executed by the processing circuitry, cause the processing circuitry to perform operations comprising the method of at least one of Examples 1-7.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instance or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for machine learning (ML) training dataset generation, the method comprising:
receiving or generating, by a scene editor, an image;
augmenting, using procedural generation, the image to include a three-dimensional (3D) model of an object resulting in a synthetic image; and
generating, by a generative model and based on the synthetic image, a realistic image.

2. The method of claim 1, further comprising training, based on real imagery from an imaging sensor and synthetic images from the scene editor, the generative model.

3. The method of claim 2, wherein the imaging sensor generates overhead imagery.

4. The method of claim 3, wherein the synthetic image includes an object placed at a geographical location, in an orientation, or for which real imagery is otherwise not available.

5. The method of claim 1, wherein procedural generation includes labelling locations in the synthetic image at which to locate the 3D model.

6. The method of claim 5, wherein procedural generation further includes generating, for each label or combination of labels, a synthetic image of the synthetic images consistent with the label or combination of labels.

7. The method of claim 1, further comprising:
receiving, by the scene editor, metadata of the image; and
automatically adjusting, by the scene editor, a lighting angle, shadow, or combination thereof, of the 3D model based on the metadata.

8. A non-transitory machine-readable medium including instructions that, when executed by a machine, cause the machine to perform operations for machine learning (ML) training dataset generation, the operations comprising:
receiving or generating, by a scene editor, an image;
augmenting, using procedural generation, the image to include a three-dimensional (3D) model of an object resulting in a synthetic image; and
generating, by a generative model and based on the synthetic image, a realistic image.

9. The non-transitory machine-readable medium of claim 8, wherein the operations further comprise training, based on real imagery from an imaging sensor and synthetic images from the scene editor, the generative model.

10. The non-transitory machine-readable medium of claim 9, wherein the imaging sensor generates overhead imagery.

11. The non-transitory machine-readable medium of claim 10, wherein the synthetic image includes an object placed at a geographical location, in an orientation, or for which real imagery is otherwise not available.

12. The non-transitory machine-readable medium of claim 8, wherein procedural generation includes labelling locations in the synthetic image at which to locate the 3D model.

13. The non-transitory machine-readable medium of claim 12, wherein procedural generation further includes generating, for each label or combination of labels, a synthetic image of the synthetic images consistent with the label or combination of labels.

14. The non-transitory machine-readable medium of claim 8, wherein the operations further comprise:
receiving, by the scene editor, metadata of the image; and
automatically adjusting, by the scene editor, a lighting angle, shadow, or combination thereof, of the 3D model based on the metadata.

15. A system for machine learning (ML) training dataset generation, the system comprising:
processing circuitry;
a memory including instructions that, when executed by the processing circuitry, cause the processing circuitry to perform operations comprising:
receiving or generating, by a scene editor, an image;
augmenting, using procedural generation, the image to include a three-dimensional (3D) model of an object resulting in a synthetic image; and
generating, by a generative model and based on the synthetic image, a realistic image.

16. The system of claim 15, wherein the operations further comprise training, based on real imagery from an imaging sensor and synthetic images from the scene editor, the generative model.

17. The system of claim 16, wherein the imaging sensor generates overhead imagery.

18. The system of claim 17, wherein the synthetic image includes an object placed at a geographical location, in an orientation, or for which real imagery is otherwise not available.

19. The system of claim 15, wherein procedural generation includes labelling locations in the synthetic image at which to locate the 3D model.

20. The system of claim 19, wherein procedural generation further includes generating, for each label or combination of labels, a synthetic image of the synthetic images consistent with the label or combination of labels.
